(19) United States
(12) Patent Application Publication
(10) Pub. No.: US 2021/0003879 A1
(43) Pub. Date: Jan. 7, 2021

(54) ELECTRICAL OR ELECTRONIC DEVICE WITH A SCREEN HAVING AN AIR VENT

(71) Applicant: P2i Ltd, Oxfordshire (GB)

(72) Inventors: William CURRAN, Reading Berkshire (GB); Zhiyong WANG, Shenzhen (CN); Donghua HUO, Shenzhen (CN); Guanrong HE, Heyuan (CN); James ROBINSON, Oxfordshire (GB)

(21) Appl. No.: 16/767,270

(22) PCT Filed: Oct. 19, 2018
(86) PCT No.: PCT/GB2018/053035

§ 371 Date: May 27, 2020

(30) Foreign Application Priority Data
Nov. 28, 2017 (CN) PCT/CN2017/113315

(51) Int. Cl. G02F 1/1333; G06F 1/16; G02F 1/13

(52) U.S. Cl. CPC G02F 1/133308; G02F 2001/133311; G02F 1/1303; G06F 1/1637

(57) ABSTRACT

A method of modifying the surface of an electrical or electronic device. The method has the steps of: placing the electrical or electronic device in a processing chamber; reducing the pressure in the processing chamber; applying a surface modification process within the processing chamber; wherein the electrical or electronic device comprises a screen (150), said screen comprising first and second layers (154, 156) separated by an air gap (172), and an air vent (196, 198) providing fluid communication between the air gap and the exterior of the electrical or electronic device, such that a reduction in pressure in the processing chamber results in a reduction in pressure in the air gap.

### TECHNICAL FIELD

The present invention relates to a method of modifying the surface of an electronic or electrical device. In particular the method relates to an electrical or electronic device comprising a screen, said screen comprising first and second layers separated by an air gap

### BACKGROUND

Many electronic or electrical devices require a screen. A typical screen comprises multiple layers which may be separated by an air gap, for example a display which shows an image and a touch panel which acts as in interface between the device and the user; the display and touch panel can be separated by an air gap to minimise the diffraction of light between the layers.

It is well known that electronic and electrical devices are very sensitive to damage caused by contamination by liquids such as environmental liquids, in particular water. Contact with liquids, either in the course of normal use or as a result of accidental exposure, can lead to short circuiting between electronic components, and irreparable damage to circuit boards, electronic chips etc.

The problem is particularly acute in relation to small portable electronic equipment such as mobile phones, smartphones, pagers, radios, hearing aids, laptops, notebooks, tablet computers, phablets and personal digital assistants (PDAs), which can be exposed to significant liquid contamination when used outside or inside in close proximity of liquids. Such devices are also prone to accidental exposure to liquids, for example if dropped in liquid or splashed.

It is desirable to protect electrical/electronic devices with a coating to protect the device from liquid damage. One method of applying a suitable coating is to use a plasma deposition technique. The use of plasma deposition techniques is known for the deposition of polymeric coatings onto a range of surfaces. This technique is recognized as being a clean, dry technique that generates little waste compared to conventional wet chemical methods. Using this method, plasmas are generated from organic molecules, which are subjected to an electrical field. When this is done in the presence of a substrate, the radicals of the compound in the plasma polymerize on the substrate. Conventional polymer synthesis will produce structures containing repeat units of the monomer species; whereas a polymer network generated using a plasma can be extremely fragmented, complex and irregular. The properties of the resultant coating can depend upon the nature of the substrate as well as the nature of the monomer used and conditions under which it is deposited.

WO2007/083122 discloses electronic and electrical devices having a liquid repellent polymeric coating formed thereon by exposure to pulsed plasma comprising a particular monomer compound, for a sufficient period of time to allow a polymeric layer to form on the surface of the electrical or electronic devices. In general, an item to be treated is placed within a plasma chamber together with material to be deposited in the gaseous state, a glow discharge is ignited within the chamber and a suitable voltage is applied, which may be pulsed.

The surfaces of electrical and/or electronic devices may be modified for reasons other than liquid repellent coatings, for example it may be desirable to apply anti-scratch or anti-glare coatings to the screen of the devices. This coating may be applied by surface modification methods which require reduction of pressure in the processing chamber.

Many surface modification methods, such as plasma modification, take place in a processing chamber which is partially evacuated during the surface modification process. It has been discovered that the reduction of pressure required in such methods can result in expansion of air trapped between layers of the screen of the electrical or electronic device. This expansion of air can cause several issues with the screen, such as screen lifting, screen delamination and/or damage to the screen.

For example, some models of smart phone use a screen comprising a back light unit, a liquid crystal display and a touch panel, where air gaps may exist between or within these components. Expansion of the air in the air gaps can cause the following effects: degrading of adhesive between the touch panel and the smart phone housing, which can result in screen lifting; deformation and/or delamination of the back light unit, which typically comprises multiple layers, resulting in lighting issues; deformation and sticking together of touch panel, liquid crystal display and/or back light unit, causing functional failure.

There remains a need to protect the screen against damage caused by low pressured experienced by the electrical or electronic device during the surface modification process. It is an object of the invention to provide a solution to this problem and/or at least one other problem associated with the prior art.

### SUMMARY OF THE INVENTION

An aspect of the present invention provides a method of modifying the surface of an electrical or electronic device, the method comprising the steps of:
placing the electrical or electronic device in a processing chamber;
reducing the pressure in the processing chamber;
applying a surface modification process within the processing chamber;
wherein the electrical or electronic device comprises a screen, said screen comprising first and second layers separated by an air gap, and an air vent providing fluid communication between the air gap and the exterior of the electrical or electronic device, such that a reduction in pressure in the processing chamber results in a reduction in pressure in the air gap.

One of the first and second layers may comprise a display. The display may comprise a liquid crystal display (LCD). Other suitable displays include organic light emitting diodes (OLED), active-matrix organic light-emitting diode (AMOLED), electrophoretic display and a plasma display panel.

The first and second layers may be separated by a spacer located between adjacent surfaces of the first and second layers, thereby forming said air gap between them; and wherein the air vent may comprise a slot in the spacer.

The spacer may be positioned in the region of the edges of the adjacent surfaces of the first and second layers, thereby defining a boundary of the air gap. The spacer may define a continuous boundary, with the exception of the air vent.

The slot in the spacer may have a non-linear path, to thereby prevent ingress or egress of light, moisture and/or dust. The non-linear path may have a zig-zag shape. Other suitable shapes include an arc and a sinusoidal curve.

The slot in the spacer may be provided with baffles, configured to prevent ingress or egress of light, moisture and/or dust. For example the slot may have a linear path, with baffles within the path.

The spacer may comprise a tape. The tape may comprise adhesive tape and adhere the two layers together. The tape may comprise a foam tape, for example a closed cell foam tape. Whilst foam adhesive tape may have some air permeability, the foam is compressed during the reduction in pressure in the processing chamber. When the device is brought back to atmospheric pressure, the foam adhesive tape remains compressed and is therefore more restrictive to air flow between the air gap and the exterior of the device through the foam.

In one embodiment the spacer comprises an adhesive, for example an adhesive layer; and wherein the slot is located in the adhesive.

The slot may have a width in the range of from 1 to 50 mm, or on the range of from 1 to 40 mm, or in the range of from 1 to 30 mm, or in the range of from 10 to 30 mm, or in the range of from 15 to 25 mm. The slot may have a width of about 10 mm, or of about 15 mm, or of about 20 mm, or of about 25 mm, or of about 30 mm.

The adhesive may comprise first and second adhesive layers. In use the first and second adhesive layers may adhere to the first and second layers respectively. One or both of the first and second adhesive layers may be discontinuous, thereby providing one or more slots. Such an arrangement may advantageously prevent light leakage from the screen. In one embodiment, only one of the first and second adhesive layers is provided with a slot.

The spacer may comprise an intermediate layer located between the first and second adhesive layers. The intermediate layer may be continuous. In this case, intermediate layer is not provided with a slot.

The spacer may comprise a tape comprising first and second adhesive layers, which in use may adhere to the first and second layers respectively. The tape may comprise a foam tape, for example a closed cell foam tape. The intermediate layer may comprise a foam layer.

The electrical or electronic device may comprise a frame to support the screen. The frame may be attached to at least one layer of the screen. For example, the screen may comprise a back light unit, a liquid crystal display and a touch panel, wherein the frame is attached to the back light unit. The frame may be provided with air holes. The air holes in the frame may be positioned to provide an air path between the air vent and the exterior of the electrical or electronic device. The air holes in the frame may be adjacent the air vent.

The pressure may be reduced to below atmospheric pressure, for example to from about 0.999×10⁵ Pa to about 1×10⁻⁷ Pa. The pressure may be reduced to less than about 1×10⁵ Pa. The pressure may be reduced to less than about 3×10³ Pa. The pressure may be reduced to less than about 1×10⁻¹ Pa. The pressure may be reduced to less than about 1×10⁻⁴Pa. In one embodiment the pressure is reduced to from about 0.700×10⁵ Pa to about 1×10⁻⁷ Pa.

In one embodiment, the surface modification process comprises a plasma deposition process and the pressure is reduced between about 1 Pa to about 3×10⁵ Pa, more preferably, 1 Pa to about 1000 Pa.

The second layer may comprise an LCD and the first layer may be selected from a back light unit or a touch panel.

The screen may comprise first, second and third layers, wherein the first layer may comprise a touch panel, the second layer may comprise a display and a third layer may comprise a back light unit and wherein the second and third layers are separated by a second air gap and wherein a second air vent provides fluid communication between the second air gap and the exterior of the electrical or electronic device. The spacer may be positioned in the region of the edges of the adjacent surfaces of second and third layers, thereby defining a boundary of the second air gap. The spacer may define a continuous boundary, with the exception of the first and second air vents. The slot in the spacer may have a non-linear path, to thereby prevent ingress of light, moisture and/or dust. The non-linear path may have a zig-zag shape. Other suitable shapes include an arc and a sinusoidal curve. The slot in the spacer may be provided with baffles, configured to prevent ingress of light, moisture and/or dust. For example the slot may have a linear path, with baffles within the path. The spacer may comprise a tape. The tape may comprise adhesive tape and adhere the two layers together. The tape may comprise a foam tape.

A screen may comprise multiple layers separated by air gaps and air vents may be provided for some or all of the air gaps.

The electrical or electronic device may be selected from mobile phones, smartphones, pagers, radios, laptops, notebooks, table computers, phablets, personal digital assistants (PDA).

Modifying the surface may comprise forming a coating on a surface of the electronic or electrical device. The coating may comprise a polymeric coating. The coating may be a protective coating from water/liquid damage. The coating may be a nanometre range film. The coating may be obtainable by exposing the electronic or electrical device or component thereof to a plasma comprising one or more saturated monomer compounds for a sufficient period of time to allow the protective polymeric coating to form on a surface thereof.

The surface modification process may comprise a plasma process. Examples of plasma processes include, plasma etching and plasma deposition processes. Plasma deposition processes include plasma enhanced chemical vapour deposition (PE-CVD) and plasma polymerisation.

The step of applying a surface modification process within the processing chamber may comprise introducing a compound into the processing chamber whilst a plasma is applied. The compound may comprise a monomer, resulting in a polymeric coating being formed on a surface of the electrical or electronic device.

A second aspect of the present invention provides an electrical or electronic device comprising a screen, said screen comprising first and second layers separated by an air gap, and an air vent providing fluid communication between the air gap and the exterior of the electrical or electronic device, such that a reduction in pressure in the processing chamber results in a reduction in pressure in the air gap

A third aspect of the present invention provides use of an air vent in an electrical or electronic device comprising a screen, said screen comprising first and second layers separated by an air gap, and the air vent providing fluid communication between the air gap and the exterior of the electrical or electronic device, to equalise pressure between a processing chamber in which the electrical or electronic device is placed and the air gap during a surface modification process which requires reduction of the pressure within the processing chamber.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 illustrates a plasma deposition apparatus;

FIG. 2 is a flow chart showing the steps of an embodiment of the method;

FIG. 3 is a flow chart showing the steps of an embodiment of the method;

FIG. 4 is a cross section of a screen for a smart phone;

FIG. 5 is a plan view of an LCD panel of the screen in FIG. 4;

FIG. 6 is a plan view of an LCD panel and frame tape of a screen for a smart phone; and

FIG. 7A is a cross section of a part of the screen of a smart phone in accordance with an alternative embodiment of the invention; and

FIG. 7B is a side view of the embodiment of FIG. 7A.

### DETAILED DESCRIPTION

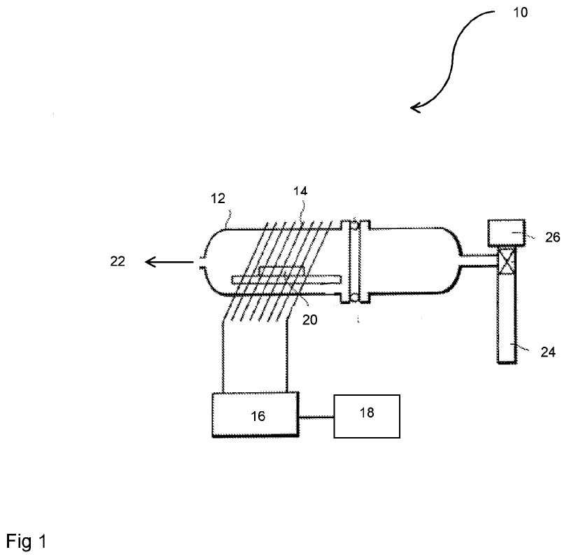

FIG. 1 is illustrates a processing apparatus 10 used for surface modification in an embodiment of the invention. A processing chamber 12 is provided with copper coils 14 connected to an RF generator 16 coupled to a power source 18 which will generate a plasma field within the processing chamber 12. The substrate 20 (in this case an electrical or electronic device) is placed in the processing chamber, which is partially evacuated using pump 22. Once the processing chamber is at the desired pressure, the plasma field is generated and a compound in vessel 24 is introduced into the processing chamber 12 via inlet 26. A suitable processing apparatus is described in WO98/58117A1, which is incorporated by reference.

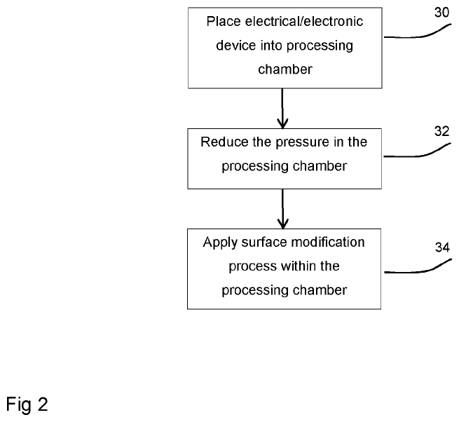

FIG. 2 illustrates the method steps of an embodiment of the method of surface modification. In a first step, the electrical/electronic device is placed in the processing chamber 30. In the next step, the pressure in the processing chamber is reduced 32. In a third step, a surface modification process is applied within the processing chamber 34.

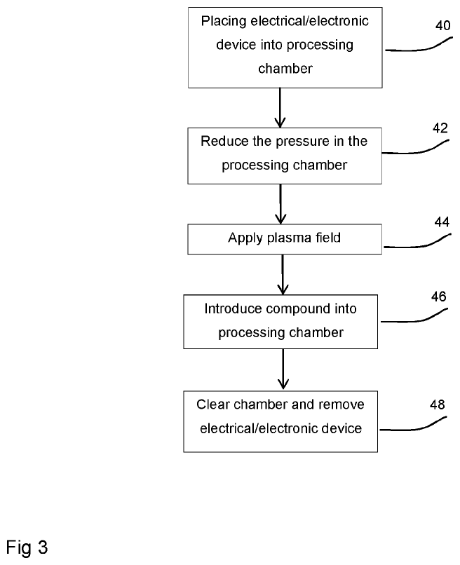

FIG. 3 illustrates the method steps of an embodiment in which the surface modification is a plasma process. In this method the electrical/electronic device is placed into the processing chamber 40. A particularly suitable apparatus and method for producing electrical or electronic devices in accordance with the invention is described in WO2005/089961, the content of which is hereby incorporated by reference. The processing chamber may be a high volume chambers, for example a chamber where the plasma zone has a volume of greater than 500 cm³, for instance 0.5 m³ or more, such as 0.5 m³-10 m³ and suitably at about 1 m³. The pressure in the processing chamber is reduced 42. The pressure will typically be in the range of from about 0.01 mbar (1 Pa) to about 300 mbar (30,000 Pa). A plasma field is applied to the processing chamber 44 and the compound is introduced into the processing chamber 46. The plasma field may have a continuous wave or pulsed field, for example the plasma may be created with a voltage a pulsed field, at an average power of from 0.001 to 500W/m³, for example at from 0.001 to 100 W/m³ and suitable at from 0.005 to 0.5W/m³. Suitable monomers include unsaturated organic compound, as described in WO98/58117 which is incorporated herein by reference. An example of suitable monomer is 1H,1H,2H,2H-heptadecafluorodecyl acrylate. Once a surface of the device has been successfully modified, the chamber is cleared and the electrical/electronic device removed 48.

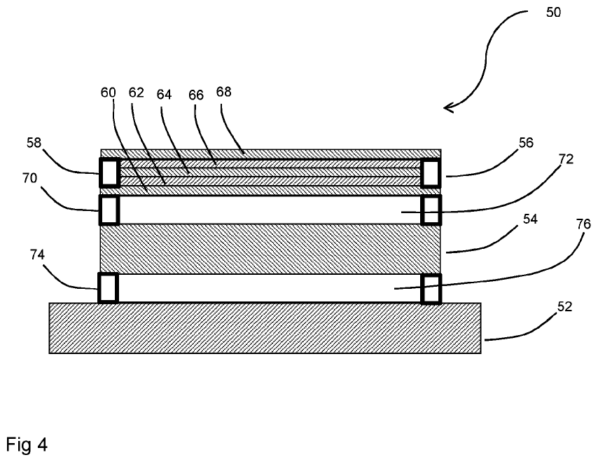

In an embodiment of the invention, the electrical/electronic device comprises a smart phone. A cross section of a typical screen of a smart phone is shown in FIG. 4. The screen 50 is made up of three layers, a touch panel (TP) 52, a liquid crystal display (LCD) 54, and a back light unit (BLU) 56. The back lit unit 56 is supported by a frame 58 and comprises multiple component layers: UP BEF layer 60, Down BEF layer 62, Diffuser layer 64, LGP layer 66 and Top Layers (Reflector) 68. The BLU 56 provides illumination to the LCD 54. The LCD 54 is mounted onto the BLU 56 by a spacer, in the form of frame tape 70, which is positioned as continuous strips at the edges of the BLU 56. The frame tape 70 is thick enough to separate the BLU 56 from the LCD 54, creating an air gap 72 between them. The touch panel 52 is mounted onto the LCD 54 by frame tape 74, positioned around the edges of the LCD 54. The frame tape 74 is thick enough to separate the LCD 54 and TP 52, creating an air gap 76 between them. The TP 52 detects touch on its surface, typically using capacitive or resistive technology and provides an interface with the smart phone.

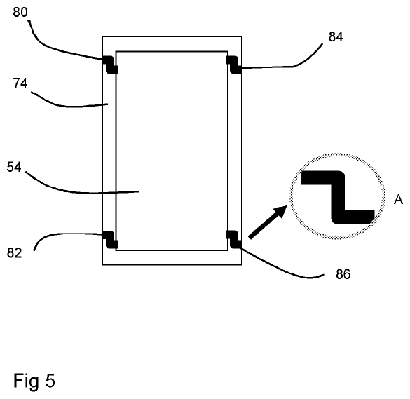

FIG. 5 is a plan view of the embodiment of FIG. 4 showing the LCD panel 54, before the TP 52 has been assembled on top. Frame tape 74 is attached to the periphery edges of the LCD panel 54. The frame tape 74 is typically an adhesive tape, used to stick the two layers together. The tape is a foam tape, for example a closed cell foam tape. A suitable tape is SHIKOH™ by Nippon Gohsei. Slots, in the form of cut outs 80,82,84,86 are provided in the frame tape 74. An enlarged view of cut out 86 is shown at A which clearly shows the ‘zig-zag’ shape of the cut out.

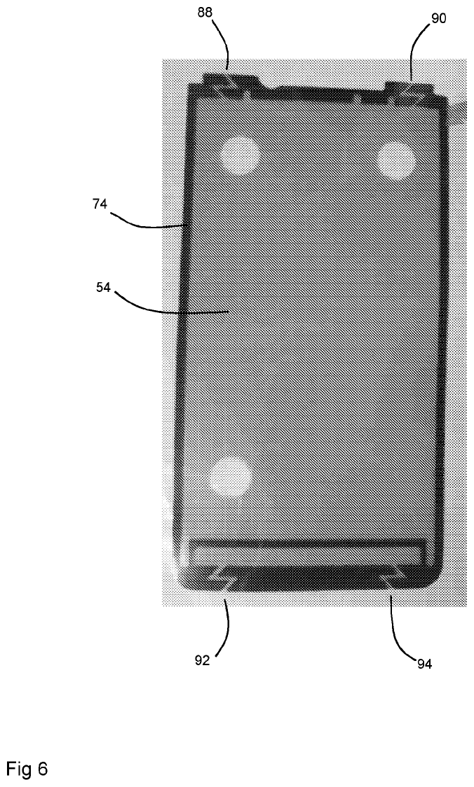

FIG. 6 is a photograph of a variant of the screen of FIGS. 4 and 5, showing the LCD display 54 and frame tape 74. Cut outs 88,90,92,94 are shown at the top and bottom of the frame tape. The cut outs can clearly be seen to have a ‘zig-zag’ shape.

The frame tape 74 seals all of the edges and therefore will severely limit or prevent any air flow in or out of the air gap 76 (likewise for frame tape 70 and air gap 72). Furthermore, the low pressure experienced in the processing chamber compresses the frame tape, further reducing any air flow. Thus the only route for air flow is through the cut outs.

The width of the frame tape may be reduced in the areas of the cut outs, to enhance air flow.

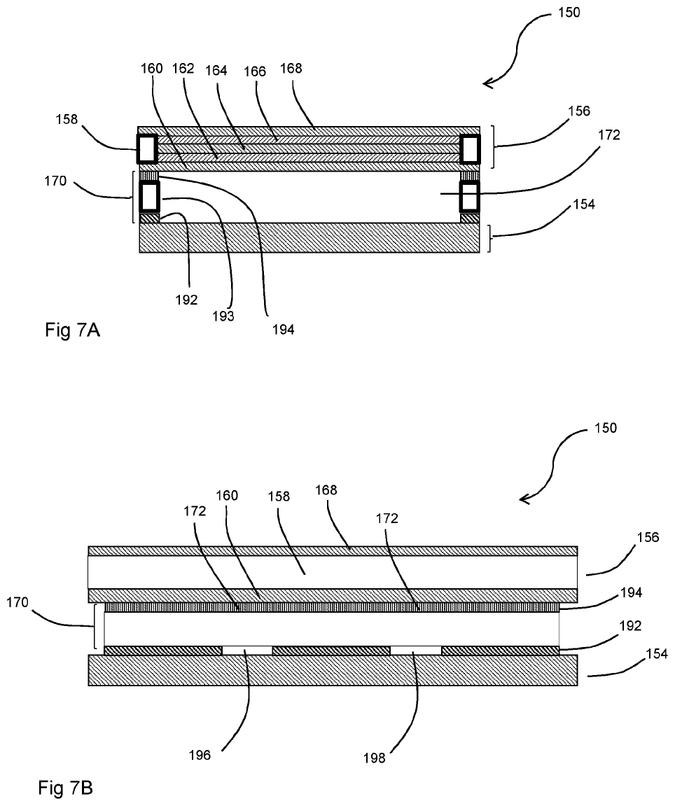

A cross section of a part of the screen 150 of a smart phone (not including a touch panel) in accordance with an alternative embodiment of the invention is shown in FIG. 7A. The part of the screen 150 comprises two layers: a liquid crystal display (LCD) 154, and a back light unit (BLU) 156.

The BLU 156 is supported by a frame 158 and comprises multiple component layers: UP BEF layer 160, Down BEF layer 162, Diffuser layer 164, LGP layer 166 and Top Layers (Reflector) 168. The BLU 156 provides illumination to the LCD 154. The LCD 154 is mounted onto the BLU 156 by a spacer, in the form of frame tape 170, which is positioned as a single continuous rectangular strip along the perimeter of the edge of the BLU 156. Unlike with the previous embodiment, in this embodiment the frame tape 170 does not have any cut outs.

The frame tape 170 is thick enough to separate the BLU 156 from the LCD 154, creating an air gap 172 between them. The frame tape 170 is a is an adhesive foam tape, for example a closed cell foam tape. It comprises a first adhesive layer 194, an intermediate layer 193, in the form of a foam layer, and a second adhesive layer 192. Both the first adhesive layer 194 and intermediate layer 193 are continuous, whilst the second adhesive layer 192 is discontinuous. The second adhesive layer 192 sticks the frame tape 170 to the LCD 154. Slots in the second adhesive layer 192 act as air vents that allow air to escape from the air gap 172 between the BLU 156 and the LCD 154 during a surface modification processes such as that described above.

The first adhesive layer 194 sticks the frame tape 170 to the UP BEF layer 160 of the BLU 156. The upper layer of adhesive 194 is a continuous layer of adhesive, which does not have any slots or other types of gap, and therefore prevents light leakage from the BLU 156 to the environment external to the part of the screen 150.

A touch panel may be mounted on the LCD 154 by a further frame tape, also having a slot in one of the adhesive layers (not shown).

FIG. 7B is a side view of the embodiment of FIG. 7A showing the BLU 156 and the LCD 154 separated by the frame tape 170. This side view shows the slots 196,198 in the second adhesive layer of adhesive 192, which act as air vents.

Smart phones having screens according to the embodiments in FIGS. 4 to 7 were found to have no leakage of light through the air vents. Smart phones both with and without air vents were tested under reduced pressure in the processing chamber and the thickness of the smart phone measured (i.e. the distance between the front face with the screen and the back face). The smart phone with air vents showed significantly smaller expansion than the smart phone without air vents, showing that the air vents had allowed the air within the air gaps to escape rather than expand.

The use of air-vents between layers of the screen reduces the expansion effectively to avoid degradation of the frame tape between the touch panel and the smartphone housing, BLU layers sticking together, and delamination of BLU layers.

1. A method of modifying the surface of an electrical or electronic device, the method comprising the steps of:
placing the electrical or electronic device in a processing chamber;
reducing the pressure in the processing chamber;
applying a surface modification process within the processing chamber;
wherein the electrical or electronic device comprises a screen, said screen comprising first and second layers separated by an air gap, and an air vent providing fluid communication between the air gap and the exterior of the electrical or electronic device, such that a reduction in pressure in the processing chamber results in a reduction in pressure in the air gap.

2. A method according to claim 1, wherein one of the first and second layers comprises a display.

3. A method according to claim 2, wherein the display comprises an LCD.

4. A method according to any one of the preceding claims, wherein the first and second layers are separated by a spacer located between adjacent surfaces of the first and second layers, thereby forming said air gap between them; and wherein the air vent comprises a slot in the spacer.

5. A method according to claim 4, wherein the spacer is positioned at or near the outer edges of the adjacent surfaces of the first and second layers.

6. A method according to any of claim 4 or 5, wherein the slot in the spacer has a non-linear path, to thereby prevent ingress of light, moisture and/or dust.

7. A method according to claim 6, wherein the non-linear path has a zig-zag shape.

8. A method according to any of claim 4 or 5, wherein the slot in the spacer is provided with baffles, configured to prevent ingress of light, moisture and/or dust.

9. A method according to any of claims 4 to 8, wherein the spacer comprises tape.

10. A method according to any of claims 4 to 9, wherein the spacer comprises adhesive tape and adheres the two layers together.

11. A method according to any of claims 4 to 10, wherein spacer comprises a foam tape.

12. A method according to any one of claims 4 to 11, wherein the slot extends the full depth of the spacer between first and second layers.

13. A method according to any of claims 4 to 11, wherein the slot extends partially through the depth of the spacer between the first and second layers.

14. A method according to any of claims 4 to 13, wherein the spacer comprises an adhesive layer and wherein the slot is located in the adhesive layer.

15. A method according to any of claims 4 to 14, wherein the spacer comprises a first adhesive layer, an intermediate layer and a second adhesive layer, wherein the slot is located in the first or second adhesive layer.

16. A method according to claim 15, wherein the intermediate layer is continuous.

17. A method according to any one of the preceding claims, wherein the electrical or electronic device comprises a frame to support the screen, and wherein the frame is provided with air holes adjacent the air vent.

18. A method according to any one of the preceding claims, wherein the pressure is reduced to from about 0.999×10⁵ Pa to about 1×10⁻⁷ Pa.

19. A method according to any one of the preceding claims, wherein the pressure is reduced to from about 0.700×10⁵ Pa to about 1×10⁻⁷ Pa.

20. A method according to any one of the preceding claims, wherein the pressure is reduced to from about 1 Pa to about 1×10⁻⁷ Pa.

21. A method according to any one of the preceding claims, wherein the pressure is reduced to from about 1 Pa to about 3×10⁵ Pa.

22. A method according to any one of the preceding claims, wherein the surface modification process comprises a plasma process, such as a plasma deposition process.

23. A method according to claim 22, wherein the plasma deposition process comprises plasma enhanced chemical vapour deposition.

24. A method according to any one of the preceding claims, wherein the electrical or electronic device is selected from mobile phones, smartphones, pagers, radios, laptops, notebooks, table computers, phablets, personal digital assistants (PDA).

25. A method according to any one of claims 2 to 24, wherein the second layer comprises an LCD and the first layer is selected from a back light unit or a touch panel.

26. A method according to any one of the preceding claims, wherein the screen comprises first, second and third layers, wherein the first layer comprises a touch panel, the second layer comprises a display and a third layer comprises a back light unit and wherein the second and third layers are separated by a second air gap and wherein a second air vent provides fluid communication between the second air gap and the exterior of the electrical or electronic device.

27. A method according claim 26, wherein the second and third layers are separated by a spacer located between adjacent surfaces of the second and third layers, thereby forming said second air gap between them; and wherein the second air vent comprises a slot in the spacer.

28. A method according to claim 27, wherein the spacer is positioned at or near the outer edges of the adjacent surfaces of the second and third layers.

29. A method according to any of claim 27 or 28, wherein the slot in the spacer has a non-linear path, to thereby prevent ingress of light, moisture and/or dust.

30. A method according to claim 29, wherein the non-linear path has a zig-zag shape.

31. A method according to any of claim 27 or 28, wherein the slot in the spacer is provided with baffles, configured to prevent ingress of light, moisture and/or dust.

32. A method according to any of claims 27 to 31, wherein the spacer comprises adhesive tape and adheres the two layers together.

33. A method according to any of claims 27 to 32, wherein the spacer comprises foam tape.

34. A method according to any one of claims 27 to 33, wherein the slot extends the full depth of the spacer between first and second layers.

35. A method according to any of claims 27 to 33, wherein the slot extends partially through the depth of the spacer between the first and second layers.

36. A method according to any of claims 27 to 35, wherein the spacer comprises an adhesive layer and wherein the slot is located in the adhesive layer.

37. A method according to any of claims 27 to 36, wherein the spacer comprises a first adhesive layer, an intermediate layer and a second adhesive layer, wherein the slot is located in the first or second adhesive layer.

38. A method according to claim 37, wherein the intermediate layer is continuous.

39. An electrical or electronic device comprising a screen, said screen comprising first and second layers separated by an air gap, and an air vent providing fluid communication between the air gap and the exterior of the electrical or electronic device, such that a reduction in pressure in the processing chamber results in a reduction in pressure in the air gap.

40. A device according to claim 39, wherein one of the first and second layers comprises a display.

41. A device according to claim 40, wherein the display comprises an LCD.

42. A device according to any one of claims 39 to 40, wherein the first and second layers are separated by a spacer located between adjacent surfaces of the first and second layers, thereby forming said air gap between them; and wherein the air vent comprises a slot in the spacer.

43. A device according to claim 42, wherein the spacer is positioned at or near the outer edges of the adjacent surfaces of the first and second layers.

44. A device according to any of claim 42 or 43, wherein the slot in the spacer has a non-linear path, to thereby prevent ingress of light, moisture and/or dust.

45. A device according to claim 44, wherein the non-linear path has a zig-zag shape.

46. A device according to any of claim 42 or 44, wherein the slot in the spacer is provided with baffles, configured to prevent ingress of light, moisture and/or dust.

47. A device according to any of claims 42 to 46, wherein the spacer comprises tape.

48. A device according to any of claims 42 to 47, wherein the spacer comprises adhesive tape and adheres the two layers together.

49. A device according to any of claims 42 to 48, wherein spacer comprises a foam tape.

50. A device according to any one of claims 42 to 49, wherein the slot extends the full depth of the spacer between first and second layers.

51. A device according to any of claims 42 to 50, wherein the slot extends partially through the depth of the spacer between the first and second layers.

52. A device according to any of claims 42 to 51, wherein the spacer comprises an adhesive layer and wherein the slot is located in the adhesive layer.

53. A device according to any of claims 42 to 52, wherein the spacer comprises a first adhesive layer, an intermediate layer and a second adhesive layer, wherein the slot is located in the first or second adhesive layer.

54. A device according to claim 53, wherein the intermediate layer is continuous.

55. A device according to any of claims 42 to 54, wherein the slot has a width in the range of 10 mm to 30 mm.

56. A device according to any one of claims 42 to 55, wherein the electrical or electronic device comprises a frame to support the screen, and wherein the frame is provided with air holes adjacent the air vent.

57. A device according to any one of the claims 42 to 56, wherein the electrical or electronic device is selected from mobile phones, smartphones, pagers, radios, laptops, notebooks, table computers, phablets, personal digital assistants (PDA).

58. A device according to any one of claims 42 to 57, wherein the second layer comprises an LCD and the first layer is selected from a back light unit or a touch panel.

59. A device according to any one of claims 42 to 58, wherein the screen comprises first, second and third layers, wherein the first layer comprises a touch panel, the second layer comprises a display and a third layer comprises a back light unit and wherein the second and third layers are separated by a second air gap and wherein a second air vent provides fluid communication between the second air gap and the exterior of the electrical or electronic device.

60. A device according to claim 59, wherein the second and third layers are separated by a spacer located between adjacent surfaces of the second and third layers, thereby forming said second air gap between them; and wherein the second air vent comprises a slot in the spacer.

61. A device according to claim 60, wherein the spacer is positioned at or near the outer edges of the adjacent surfaces of the second and third layers.

62. A device according to claims 60 or claim 61, wherein the slot in the spacer has a non-linear path, to thereby prevent ingress of light, moisture and/or dust.

63. A device according to claim 62, wherein the non-linear path has a zig-zag shape.

64. A device according to any of claim 60 or 63, wherein the slot in the spacer is provided with baffles, configured to prevent ingress of light, moisture and/or dust.

65. A device according to any of claims 60 to 64, wherein the spacer comprises adhesive tape and adheres the two layers together.

66. A device according to any of claims 60 to 65, wherein the spacer comprises foam tape.

67. A device according to any one of claims 60 to 66, wherein the slot extends the full depth of the spacer between first and second layers.

68. A device according to any of claims 60 to 67, wherein the slot extends partially through the depth of the spacer between the first and second layers.

69. A device according to any of claims 60 to 68, wherein the spacer comprises an adhesive layer and wherein the slot is located in the adhesive layer.

70. A device according to any of claims 60 to 69, wherein the spacer comprises a first adhesive layer, an intermediate layer and a second adhesive layer, wherein the slot is located in the first or second adhesive layer.

71. A device according to claim 70, wherein the intermediate layer is continuous.
